(19) United States
(12) Patent Application Publication
(10) Pub. No.: US 2026/0045820 A1
(43) Pub. Date: Feb. 12, 2026

(54) AUTOMATIC CHARGING FOR ELECTRONIC DEVICES

(71) Applicants: ZHEJIANG DESMAN INTELLIGENT TECHNOLOGY CO., LTD., Hangzhou (CN); ZHEJIANG DEBOMAN INTELLIGENT MANUFACTURING CO., LTD., Hangzhou (CN)

(72) Inventors: Zhenxin LIU, Hangzhou (CN); Shaohua CHANG, Hangzhou (CN); Zhiling ZHU, Hangzhou (CN); Shengwei SANG, Hangzhou (CN); Xingzhu HUANG, Hangzhou (CN); Yehao DENG, Hangzhou (CN); Fei YE, Hangzhou (CN)

(73) Assignees: ZHEJIANG DESMAN INTELLIGENT TECHNOLOGY CO., LTD., Hangzhou (CN); ZHEJIANG DEBOMAN INTELLIGENT MANUFACTURING CO., LTD., Hangzhou (CN)

(21) Appl. No.: 19/362,975

(22) Filed: Oct. 20, 2025

Related U.S. Application Data
(63) Continuation-in-part of application No. PCT/CN2024/099841, filed on Jun. 18, 2024.

(30) Foreign Application Priority Data
Apr. 20, 2023 (CN) 202310452498.4

(51) Int. Cl. H02J 7/00; H02J 7/34

(52) U.S. Cl. CPC H02J 7/00712; H02J 7/0047; H02J 7/345; H02J 2207/50

(57) ABSTRACT

In some embodiments, an automatic charging device for electronic devices, such as a smart door lock, includes a charging receiving terminal comprising: an optical receiver configured to receive light energy from external light sources and convert the light energy from the external light sources to electrical energy; and an energy storage coupled to the optical receiver and configured to store the electrical energy from the optical receiver and further provide the electrical energy to charge the electronic device. The automatic charging device can be controlled to transfer electric energy from the optical receiver to the energy storage to the power unit of the electronic device in a manner such that the electronic device can remain in a powered state, avoiding the necessity of removing the battery for charging.

### RELATED APPLICATIONS

The present disclosure is a Continuation-in-part of International Application No. PCT/CN2024/099841 filed Jun. 18, 2024, which claims the priority of the Chinese patent application No. 202310452498.4 filed Apr. 20, 2023. The entire contents of both of these applications are incorporated herein by reference.

### FIELD

The present disclosure relates to charging for electronic devices, and in particular, relates to an automatic charging device for electronic devices and smart door locks.

### BACKGROUND

Electronic devices are developing rapidly and have gradually become the main market demands. With increasingly powerful functions in these devices, demands for battery life have also increased. In existing smart door lock products, the battery life generally ranges from 1 to 6 months. Further, when users need to charge the battery, they usually have to replace the battery regularly, remove the battery for charging, or switch to a spare battery. These operations are rather cumbersome, and some functions for the electronic devices, e.g., the door lock and cameras, may fail to work normally during the battery charging period, which also affects the user experience. As such, there is a need to increase the battery life in electronic devices, such as smart door locks and other devices without requiring users to change batteries frequently or perform any maintenance operations. The technical solutions described in the present disclosure address the above technical issues and/or other issues.

### SUMMARY

Systems and methods are provided for automatically charging smart door locks. In some aspects, an automatic charging device for a smart door lock includes a charging receiving terminal. The charging receiving terminal includes: an optical receiver configured to receive light energy from external light sources and convert the light energy from the external light sources to electrical energy; an energy storage comprising coupled to the optical receiver and configured to store the electrical energy from the optical receiver and further provide the electrical energy to charge the smart door lock; a charging management circuit coupled to the optical receiver and the energy storage and configured to release the electrical energy from the optical receiver to the energy storage; and a main control circuit configured to monitor a status of the energy storage and the smart door lock, and control the charging management circuit to transfer the electrical energy from the optical receiver to the energy storage.

In some aspects, a method for automatically charging a smart door lock includes: determining remaining power of a first battery in the smart door lock; determining whether detection functions for a first power threshold and a third power threshold are turned on; in response to determining that the detection functions for the first power threshold and the third power threshold are turned on, controlling a discharging management circuit in a charging device to start or suspend charging the first battery according to comparisons between the remaining power of the first battery and the first power threshold, and between the remaining power of the first battery and the third power threshold, respectively; and in response to determining that the detection functions for the first power threshold and the third power threshold are not turned on, controlling the discharging management circuit to continuously charge the first battery.

In some aspects, an automatic charging device for electronic devices, e.g., a battery-operated electronic device is coupled to the electronic device to provide charge to the electronic device. The automatic charging device includes a charging receiving terminal comprising: an optical receiver configured to receive light energy from external light sources and convert the light energy from the external light sources to electrical energy; an energy storage comprising a second battery, the energy storage being coupled to the optical receiver; a charging management circuit coupled to the optical receiver and the energy storage and configured to release the electrical energy from the optical receiver to the second battery of the energy storage; a discharging management circuit coupled to the energy storage and the electronic device and configured to release the electrical energy from the energy storage and charge the first battery; and a main control circuit configured to monitor a status of the energy storage and the electronic device, and control the charging management circuit and the discharging management circuit to transfer the electrical energy from the optical receiver to the second battery to the first battery.

### BRIEF DESCRIPTION OF DRAWINGS

In order to more clearly illustrate the specific embodiments of the present disclosure, the accompanying drawings required for describing the specific embodiments will be briefly introduced below. Obviously, the accompanying drawings in the following description are some embodiments of the present disclosure, and for those of ordinary skill in the art, other drawings can also be obtained without departing from the scope of the present disclosure. For example, FIGS. 1-12 illustrate example embodiments for automatic charging for battery-operated electronic devices using a smart door lock as an example. It is appreciated and various embodiments in FIGS. 1-12 can also be used for other types of battery-operated electronic devices.

Additional embodiments of the disclosure, as well as features and advantages thereof, will become more apparent by reference to the description herein taken in conjunction with the accompanying drawings. The components in the figures are not necessarily to scale. Moreover, in the figures, like-referenced numerals designate corresponding parts throughout the different views.

FIG. 1 is a schematic diagram of an example smart door lock system according to some embodiments of the present disclosure;

FIG. 2 is a schematic diagram of an example charging receiving terminal that may be included in an automatic charging device for a smart door lock according to some embodiments of the present disclosure;

FIG. 3 is a schematic diagram of an example charging transmitting terminal that may provide light energy to an automatic charging device for a smart door lock according to some embodiments of the present disclosure;

FIG. 4 illustrates a light energy transmission path between an example charging transmitting terminal and an example charging receiving terminal in an automatic charging device for a smart door lock according to some embodiments of the present disclosure;

FIG. 5 is a schematic diagram of an example automatic charging device for a smart door lock according to some embodiments of the present disclosure;

FIG. 6 is a block diagram of an example housing of an automatic charging device for a smart door lock according to some embodiments of the present disclosure;

FIG. 7 is a schematic diagram of an energy conversion process that may be implemented in an automatic charging device for a smart door lock according to some embodiments of the present disclosure;

FIG. 8 is a schematic diagram of an example charging receiving terminal in an automatic charging device for a smart door lock according to some embodiments of the present disclosure;

FIG. 9 is a schematic diagram of example voltage stabilizers that may be implemented in a charging receiving terminal in an automatic charging device for a smart door lock according to some embodiments of the present disclosure;

FIG. 10 is a flow diagram of an example automatic charging method that may be implemented in a smart door lock system according to some embodiments of the present disclosure;

FIG. 11 is a flow diagram of another example automatic charging method that may be implemented in a smart door lock system according to some embodiments of the present disclosure;

FIG. 12 is a flowchart of yet another automatic charging method for a smart door lock system according to some embodiments of the present disclosure; and

FIG. 13 is schematic diagram of an example computer device that may be implemented in an automatic charging device for electronic devices according to some embodiments of the present disclosure.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of the invention is thereby intended. For example, it should be appreciated that the embodiments described herein may be implemented in any of numerous ways. Examples of specific implementations are provided below for illustrative purposes only. It should be appreciated that these embodiments and the features/capabilities provided may be used individually, all together, or in any combination of two or more, as aspects of the technology described herein are not limited in this respect. Further, it should be noted that the acts shown in various flow diagram of the accompanying drawings can be executed in a computer system such as one with a set of computer-executable instructions. Although a logical order is shown in each flow diagram, in some cases, the acts shown or described can be executed in an order different from that therein.

In some embodiments, an automatic charging device for electronic devices is provided. Examples of electronic devices may include battery-operated electronic devices, such as smart door locks, door bells, surveillance cameras, security alarm systems, routers and other network devices, cat-eye cameras, in-door displays, and cloud storage or other internet-of-things (IoT) and AI-of-things (AoT) devices. By configuring an optical receiver to receive light energy from external light sources, the automatic charging device converts light energy into electrical energy and charges an energy storage. The energy storage may be configured to receive the electrical energy from the optical receiver and charge the electronic device. This achieves the effect of prolonging the service life of the battery of the electronic device and, as a result, does not require users to change battery of the electronic device or perform maintenance operation of the battery.

Various embodiments of system and method for automatically charging of electronic devices are provided herein using a smart door lock or a smart door lock system as an example. It is appreciated that these embodiments are also suitable for other types of electronic devices, such as battery-operated electronic devices.

Examples of a smart door lock may include any electronic door locks that can be actuated electronically. For example, a smart door lock may be an electronic door lock that includes a door lock (e.g., a spring loaded latch or a deadbolt) that can securely lock the door and a keypad that allows users to program and actuate the door lock electronically. A smart door lock may also include an electronic door lock and additional peripherals such as a camera or fingerprint sensor to allow entry of the door via biometric verification, or a door bell, or any suitable audio/visual input and output devices. In other examples, a smart door lock may include communication interfaces such as Wi-Fi or other communication interface, wired or wirelessly, to communicate with a user device or the Internet. This may enable control of the smart door lock remotely, e.g., via an app on a user's smart phone or the cloud.

In some configurations, a door lock body of a smart door lock may include a lock body for securely locking the door, one or more sensors (such as fingerprint sensors, keypad, infrared sensors, etc.), a controller, an actuator (motor), and a power supply (which provides energy for the operation of the smart door lock).

In some configurations, a front panel of a smart door lock (facing outside) may include electronic identification components such as fingerprint recognition, password input, wireless card reader (e.g., NFC card reader), and facial recognition. Some configurations may include a sliding cover to protect the internal components. A rear panel of a smart door lock (facing inside) may include a battery compartment and a manual locking knob for indoor operation.

In some configurations, when the sensor in a smart door lock detects an unlocking signal (e.g., fingerprint match or correct password), it transmits the signal to the controller. After analyzing the signal, the controller sends a command to the actuator, which drives the motor to actuate the lock body and unlock the door.

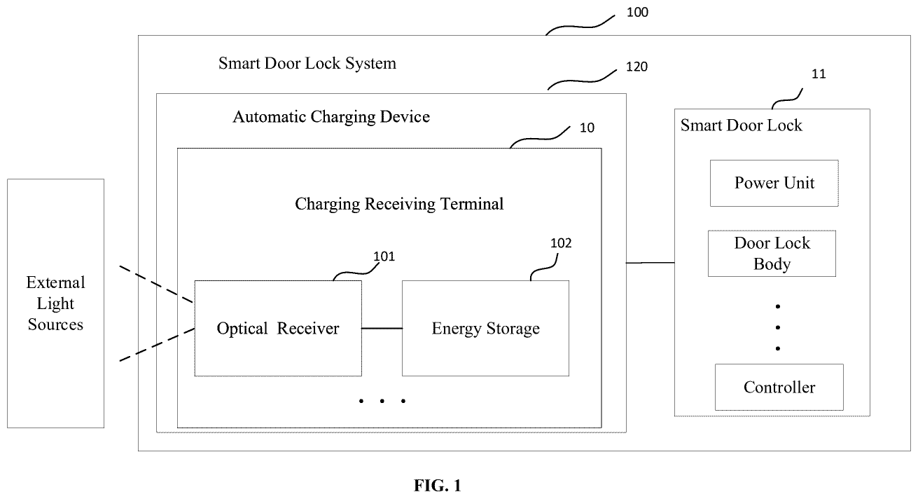

FIG. 1 is a schematic diagram of an example smart door lock system 100 according to some embodiments of the present disclosure. As shown in FIG. 1, smart door lock system 100 may include an automatic charging device 120. Automatic charging device 120 may include a charging receiving terminal 10, which includes an optical receiver 101 and an energy storage 102. The optical receiver 101 is configured to receive light energy from external light sources, convert light energy into electrical energy to provide charge to the energy storage 102. Energy storage 102 is configured to receive the electrical energy from the optical receiver 101 and charge the smart door lock 11. It is appreciated that any other types of electronic device systems may include an electronic device and an automatic charging device similarly configured as automatic charging device 120.

In some embodiments, the external light source may be a solar light source or an artificially provided light source (e.g., an LED light source), and the optical receiver 101 may adopt a solar panel to receive light energy from the external light source. In some examples, the LED light source may produce white light. For example, white light may be a combination of colors in the visible light spectrum. In non-limiting examples, white light produced by the external light source may have a spectrum in the range of 400˜800 nm.

In some embodiments, when the optical receiver 101 (e.g., solar panel) receives sunlight or LED light, the light energy is converted into the electrical energy to be stored in the automatic charging device (e.g., energy storage 102), and the automatic charging device receives the electrical energy from the solar panel to charge the smart door lock 11.

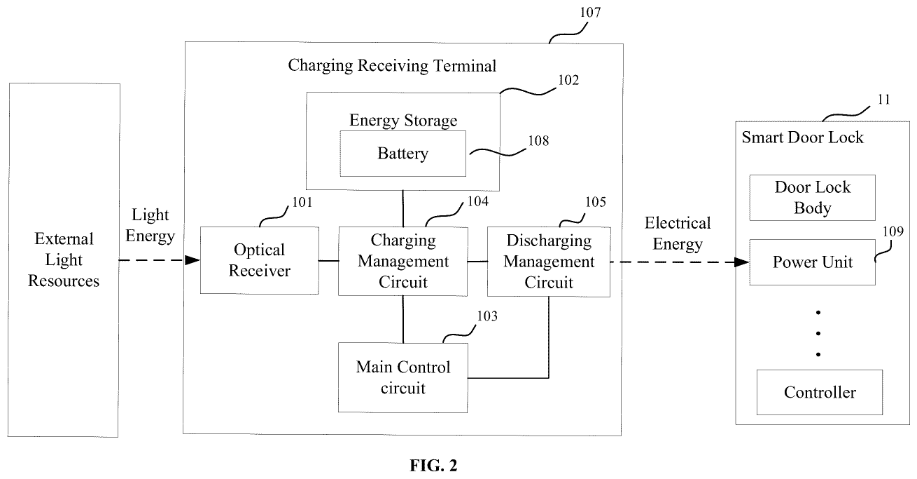

FIG. 2 is a schematic diagram of an example charging receiving terminal that may be included in an automatic charging device for a smart door lock according to some embodiments of the present disclosure. In some embodiments, charging receiving terminal 107 may be implemented in automatic charging device 120 (FIG. 1), e.g., in charging receiving terminal 10. In FIG. 2, charging receiving terminal 107 may include optical receiver 101 and energy storage 102. Energy storage 102 may include a battery 108, e.g., a lithium battery, or any suitable component that can store and discharge electrical energy. Examples of such components may include also one or more battery packs and capacitors. Charging receiving terminal 107 may further include a main control circuit 103, a charging management circuit 104, and a discharging management circuit 105.

In some embodiments, main control circuit 103 is configured to monitor the status of the energy storage 102 and the smart door lock 11, and control the activation and deactivation of the charging management circuit 104 and the discharging management circuit 105. In response to a control signal from the main control circuit 103, the charging management circuit 104 is configured to operate in a charge state to release electrical energy from the optical receiver 101 to the energy storage 102 (e.g., charging battery 108 in the energy storage), or in a suspend state to suspend (stop) charging the energy storage 102. Similarly, in response to a control signal from the main control circuit 103, the discharging management circuit 105 is configured to operate in a charge state to release electrical energy from the energy storage 102 to the smart door lock 11 (e.g., charging a power unit 109 including a battery), or in a suspend state to suspend (stop) charging the battery in the smart door lock.

Now, the charging receiving terminal is further described with reference to FIGS. 7-9. FIG. 7 is a schematic diagram of an energy conversion process that may be implemented in an automatic charging device for a smart door lock (or other electronic devices) according to some embodiments of the present disclosure. For example, energy conversion process 700 may be implemented in one or more portions of a charging receiving terminal, such as 10 (in FIGS. 1) and 107 (in FIG. 2). Solar panel 701 may implement optical receiver 101 in FIGS. 1 and 2. Charging management circuit 704 may implement charging management circuit 104 in FIG. 2. Discharging management circuit 705 may implement discharging management circuit 105 in FIG. 2. Energy storage 702 may implement energy storage 102 in FIGS. 1 and 2. Main control circuit 703 may implement main control circuit 103 in FIG. 2. Output interface 707 may be provided in a charging receiving terminal (e.g., 10 in FIGS. 1, 107 in FIG. 2) to interface with the electronic device, such as a smart door lock (e.g., 11 in FIGS. 1 and 2). An example of the output interface 707 may include an output terminal that connects the charging receiving terminal 107 to a power unit 109 of smart door lock 11 to transfer electrical energy to the smart door lock.

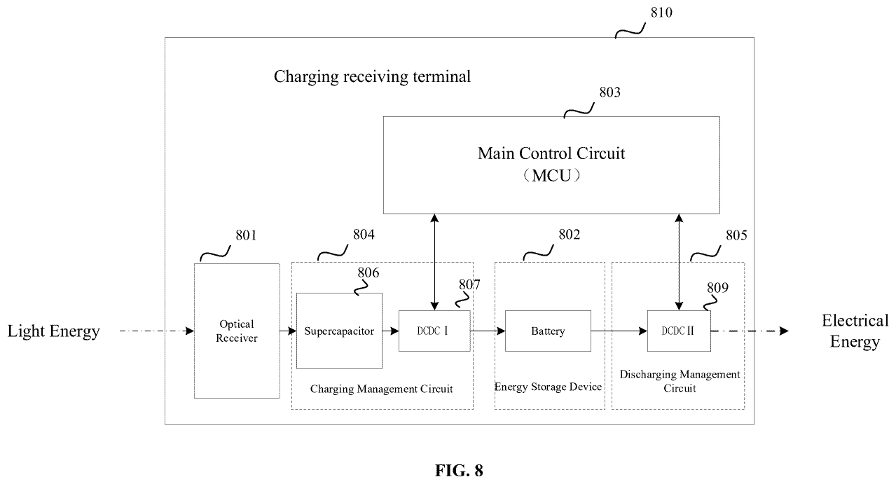

FIG. 8 is a schematic diagram of an example charging receiving terminal 810 in an automatic charging device for a smart door lock (or other electronic devices) according to some embodiments of the present disclosure. In some embodiments, charging receiving terminal 810 may be implemented in charging receiving terminal 10 (in FIGS. 1) and 107 (in FIG. 2). Charging receiving terminal 810 may be structured in a similar manner as charging receiving terminal 107 (in FIG. 2). For example, optical receiver 801, charging management circuit 804, energy storage 802, discharging management circuit 805 may respectively implement optical receiver 101, charging management circuit 104, discharging management circuit 105, and energy storage 102 (in FIG. 2).

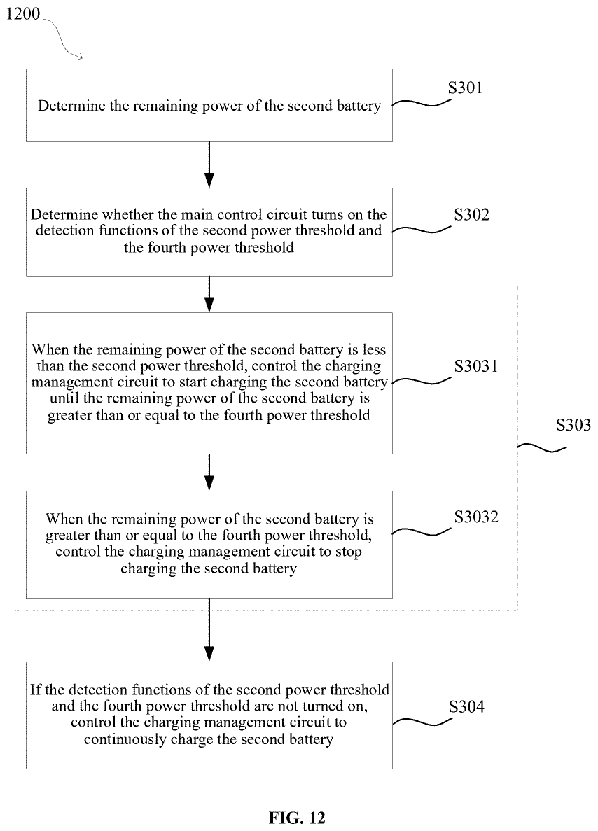

With further reference to FIGS. 7-8, the main control circuit (e.g., 700 in FIGS. 7, 803 in FIG. 8) may include a main control unit (Microcontroller Unit, or MCU), which monitors the statuses of the power unit of the smart door lock (e.g., 109 in FIG. 2) and the energy storage (e.g., energy storage 102 in FIGS. 2, 702 in FIGS. 7, 802 in FIG. 8). For example, MCU 803 may monitor the remaining powers of the batteries in the power unit of the smart door lock and the energy storage in the charging receiving terminal, respectively. Examples of monitoring are described further in FIGS. 11 and 12 (e.g., acts S201, S301).

Returning to FIG. 8, the charging management circuit 810 may further include a supercapacitor 806 coupled to the optical receiver 801 and configured to store electrical energy from the optical receiver. When optical receiver 101 receives light energy from the external light sources, the light energy is converted to the electrical energy and stored in the supercapacitor 806 to be transferred to the battery in the energy storage 802. In practical environments, the lighting conditions constantly change due to weather, passing clouds, leaf shading, etc. These changes can cause significant fluctuations in the output voltage of the optical receiver (e.g., the solar panel). The supercapacitor can function to rapidly absorb or release huge instantaneous power, compensating for voltage fluctuations caused by changes in illumination. In other words, the supercapacitor acts as a buffer to enhance the operational stability of the entire circuit.

The inventors have recognized and acknowledged that the battery in the energy storage (e.g., 802) and the battery in the smart door lock (e.g., power unit 109 in FIG. 2) or other electronic devices may have different voltages depending on the status of the batteries, such as the remaining power in each battery. In a non-limiting example, at a given time, the voltage for the supercapacitor may be 7v, the voltage for the battery in the energy storage may be 5v, and the voltage for the battery in the smart door lock may be 4v. Accordingly, one or more voltage stabilizers may be used to properly transfer electrical energy from the optical receiver to the battery in the energy storage and to the battery in the smart door lock.

In some embodiments, with reference to FIG. 8, the charging management circuit 804 may further include a voltage stabilizer 807 coupled to the supercapacitor 806 and the battery of the energy storage 802. In such configuration, the electrical energy stored in the supercapacitor is transferred by the voltage stabilizer 807 to the battery in the energy storage 802, where the voltage stabilizer 807 stabilizes the voltage for the battery in the energy storage. This protects the battery in the energy storage from fluctuations of voltages that may be generated by the external light source. For example, when solar light is used, due to the weather and environments in the proximity of the premises where the smart door lock system is install, the level of light energy may vary greatly, resulting in varying voltages for the supercapacitor. The voltage stabilizer may also output a voltage at a proper value required by the battery in the energy storage depending on the status of the battery. For example, the voltage on the battery in the energy storage may vary depending on the remaining power in these batteries.

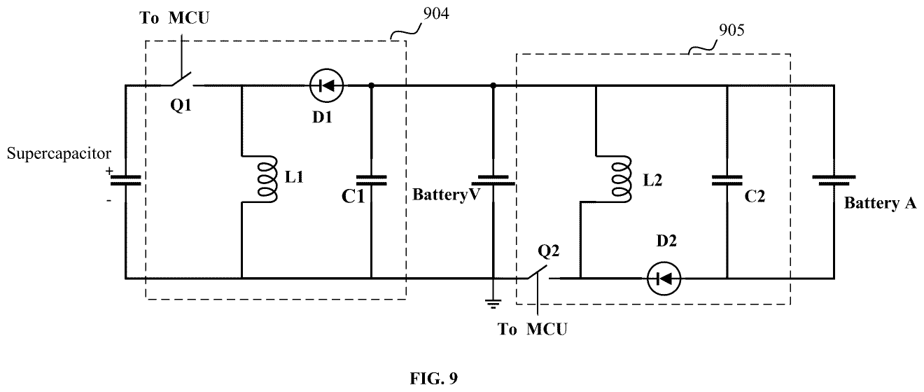

In some embodiments, the discharging management circuit 805 may be configured in a similar manner as charging management circuit 804. For example, discharging management circuit 805 may include a voltage stabilizer similarly configured as voltage stabilizer 807 to receive electrical energy from the energy storage 802, perform voltage stabilization and charge the battery in the smart door lock (e.g., a battery in power unit 109 in FIG. 2). Now, the voltage stabilizers for charge management circuit 804 and discharging management circuit 805 are described further in detail in FIG. 9.

FIG. 9 is a schematic diagram of example voltage stabilizers (e.g., 904, 905) that may be implemented in a charging receiving terminal in an automatic charging device for a smart door lock according to some embodiments of the present disclosure. In some embodiments, voltage stabilizer 904 may be implemented in charging receiving terminal 810 (see voltage stabilizer 807 in FIG. 8). Voltage stabilizer 905 may be implemented in charging receiving terminal 810 (see voltage stabilizer 809 in FIG. 8). In FIG. 9, supercapacitor may implement supercapacitor 806 (in FIG. 8); Battery V may be included in energy storage (e.g., 802 in FIG. 8) and Battery A may be included in power unit 109 of smart door lock 11 (in FIG. 2).

In some implementations, the voltage stabilizer 904 may include a DC-DC converter including a controllable switch Q1, which may be coupled to the supercapacitor. The controllable switch Q1 may be coupled to the MCU (in FIG. 8) to receive a control signal from the MCU that can control activate or deactivate the voltage stabilizer 904 (and thus the charging management circuit). In a non-limiting example, switch Q1 may be a MOSFET transistor, where the base (or gate) of the transistor is connected to the MCU (e.g., via an I/O pin). In such manner, the MCU may provide a control signal to the MOSFET transistor to activate the voltage stabilizer to cause the charging management circuit to operate in a charge state. MCU may also deactivate the voltage stabilizer 904 with an open circuit and not providing the control signal to switch Q1. This will cause the charging management circuit to operate in a suspend state. It is appreciated that switch Q1 may be implemented in any other suitable manner and controlled by the MCU to activate or deactivate the voltage stabilizer.

With further reference to FIG. 9, voltage stabilizer 905 may be provided in the discharging management circuit 805 (FIG. 8) and coupled to the energy storage (e.g., Battery V) and the battery in the smart door lock (e.g., Battery A). Voltage stabilizer 905 may be structured in a similar manner as voltage stabilizer 904. For example, voltage stabilizer 905 may include a DC-DC converter, including a controllable switch Q2 implemented in a similar manner as switch Q1. In some examples, switch Q2 may include a MOSFET transistor, where the base (or gate) of the transistor is coupled to the MCU (e.g., via an I/O pin) to receive a control signal. In such manner, the MCU may provide a control signal to the transistor to activate or deactivate the voltage stabilizer 905 (and thus the discharging management circuit) in a similar manner as activating/deactivating the voltage stabilizer 904 via switch Q1.

In some examples, MCU 803 may include PWM I/O pins respectively coupled to the switches Q1 and Q2, to provide control signals thereto. In non-limiting examples, when activating voltage stabilizer 904, MCU 803 may generate a Pulse Width Modulation (PWM) signal to control switch Q1 to alternately turn on and off. In such manner, electrical energy stored in the supercapacitor may be released to Battery V via the voltage stabilizer 904. As a result, a smooth and stable DC output voltage is provided across the load Battery V. In some examples, the polarity of its output voltage at Battery V is opposite to that of the input voltage at the supercapacitor.

In some embodiments, when activating voltage stabilizer 905, MCU 803 may generate a PWM signal to control switch Q2 to alternately turn on and off in a similar manner as controlling switch Q1. In such manner, electrical energy stored in the energy storage (e.g., Battery V) may be released to the battery in the smart door lock (e.g., Battery A) via the voltage stabilizer 905. As a result, a smooth and stable DC output voltage is provided across the load Battery A. In some examples, a smooth and stable output voltage opposite in polarity to that at Battery V is provided at Battery A (in the smart door lock). As described above and further herein, the voltage stabilizers 904, 905 function to transfer electrical energy from the supercapacitor to Battery V and to Battery A by providing a smooth and stable voltage at each battery.

In operation, MCU may generate respective control signals for voltage stabilizers 904 and 905. In some embodiments, each of the control signals may be a PWM signal having a respective frequency and duty cycle (e.g., the ratio of the switch conduction time to the total period within one cycle). In each voltage stabilizer, the switch alternately turns on or off in response to the PWM control signal, by which the voltage stabilizer operates in two stages corresponding to the high voltage and low voltage of the PWM signal, respectively. By repeating these two stages, the circuit completes energy transfer and conversion. By adjusting the duty cycle of the PWM signal (D), the output voltage can be regulated. For example, to regulate the output voltage, a voltage conversion relationship of the voltage stabilizer circuit is: Vout=−Vin*(D/(1−D)), where Vout is the output voltage, Vin is the input voltage, and D is the duty cycle. From this relationship, it can be seen that: when the duty cycle D<0.5, the circuit operates in Step-Down Mode, |Vout|<Vin. When the duty cycle D>0.5, the circuit operates in Step-Up Mode, |Vout|>Vin. When the duty cycle D=0.5, |Vout|=Vin.

The various embodiments in FIG. 9 provide advantages in a wide voltage adaptation range, where the circuit is capable of stably outputting the required voltage even when the input voltage fluctuates significantly, especially when the input voltage may be higher or lower than the output voltage. As such, a stable voltage can be maintained for the energy storage (e.g., lithium battery) and the battery of the smart door lock or other electronic devices. Additional advantages include flexible voltage conversion capability, by which seamlessly switches between step-down and step-up modes through a control parameters (e.g., duty cycle and frequency) can be achieved, resulting in simple control and rapid response. In FIG. 9, the circuit has relatively simple structure and components of small sizes. Such configuration results in reduced costs while providing improved system reliability.

Returning to FIG. 1, there may be various ways to provide external light sources to the automatic charging device 120. In some examples, the external light source may be natural solar light or ambient light in the proximity of the premises where the smart door lock system is installed. The inventors have recognized and acknowledged that the charging receiving terminal (e.g., 10 in FIG. 1 and similar systems in FIGS. 2 and 5-9) may fail to receive proper light energy from the external light sources, such as when the natural light around the smart door lock is dim or when the smart door lock is in a dark environment. Accordingly, a charging transmitting terminal can be provided to provide the external light sources.

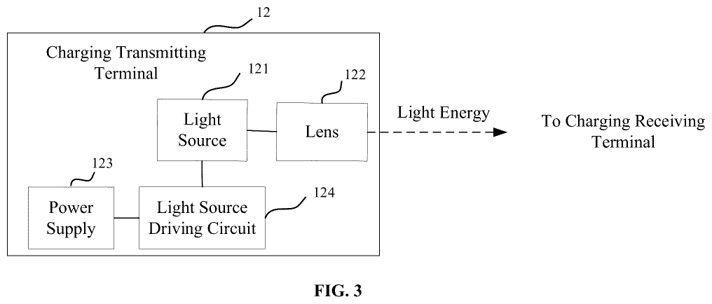

FIG. 4 illustrates a light energy transmission path between an example charging transmitting terminal and an example charging receiving terminal in an automatic charging device for a smart door lock according to some embodiments of the present disclosure. In FIG. 4, a light energy transmission path may be established between an example charging transmitting terminal 412 and an example charging receiving terminal 410 in an automatic charging device for a smart door lock according to some embodiments of the present disclosure. In some examples, charging receiving terminal 410 may be implemented in charging receiving terminal 107 (in FIG. 7) or other similar systems in FIG. 2, and 5-9. Now, the charging transmitting terminal is described further with reference to FIG. 3.

FIG. 3 is a schematic diagram of an example charging transmitting terminal 12 that may provide light energy to an automatic charging device for a smart door lock according to some embodiments of the present disclosure. In some embodiments, charging transmitting terminal 12 in charging transmitting terminal 412 (in FIG. 4). In some examples, charging transmitting terminal 12 may provide light energy to the charging receiving terminal described in embodiments in FIGS. 1, 2, and 4-9. In FIG. 3, charging transmitting terminal 12 may include a light source 121 and a lens 122. The light beam output by the light source 121 is focused by the lens 122 and then provided to a charging receiving terminal, such as those described in embodiments in FIGS. 1, 2, and 4-9. The charging transmitting terminal 12 may further include a power supply 123 and a light source driving circuit 124, where the power supply 123 supplies power to the light source 121 through the light source driving circuit 124.

In FIG. 3, the light source 121 may be an LED light source positioned in the proximity of and in alignment with the optical receiver (e.g., 101 in FIGS. 1-2) such that light energy from the LED light source can be efficiently received in the optical receiver. Power supply 123 supplies power to the light source through the light source driving circuit 124. Lens 122 may be disposed between the LED light source and the optical receiver. When powered on, the light source emits a light beam, which is focused by the lens 122 and then irradiates the optical receiver (e.g., 101 in FIG. 1). The light source driving circuit 124 is configured to convert the input power supply voltage (e.g., AC power in a building, e.g., 110V or 220V or a regulated power supply voltage in any market), and transform the high voltage into low voltage to power the LED light source. Generally, LED light sources operate in a low-voltage mode, and the light source driving circuit can protect the LED light source from being easily damaged during operation.

In some embodiments, the light source driving circuit 124 may be implemented using a suitable LED light driver. For example, the driver circuit may include multiple stages, including an electromagnetic interference filtering and input rectification stage to provide a single-polarity, full-wave, pulsating DC voltage from the input voltage (e.g., AC 110V); a power factor correction stage, in which the pulsating DC voltage output from the previous stage is boosted and stabilized to a DC bus voltage with a higher amplitude (e.g., approximately 400VDC) and lower ripple, while also improving the system's power factor (e.g., to above 0.9); a DC-DC conversion and electrical isolation stage to produce a smooth and stable low-voltage DC output; and a constant current drive and output stage to deliver a constant, configurable drive current to the LED light source, which can suppress the fluctuations in the input voltage or the LED forward voltage, ensuring stable, reliable, and long-lasting illumination.

The smart door lock system including the automatic charging device for a smart door lock provided in various embodiments of the present disclosure monitors the status (e.g., remaining power) of the energy storage and the smart door lock via the main control circuit, and controls the charging management circuit and the discharging management circuit to activate or deactivate based on the monitoring results (see example methods in FIGS. 11 and 12). As a result, electrical energy converted from the light sources are transferred via charging management circuit to energy storage and to the battery of the smart door lock via discharging management circuit. By configuring the automatic charging device properly, both the energy storage and the smart door lock can be maintained in a powered state and provide continuous power to the smart door lock, avoiding the necessity of removing the battery of the smart door lock for charging.

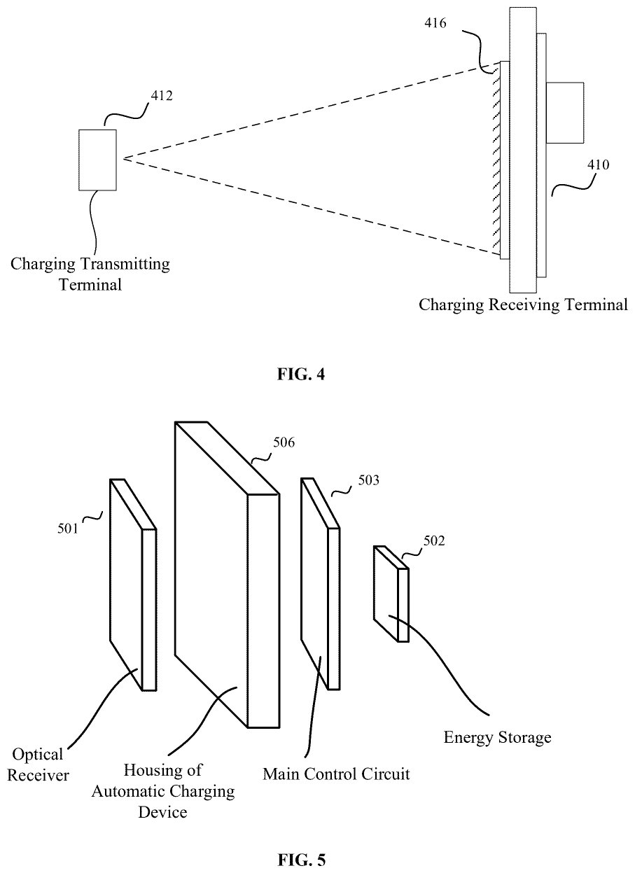

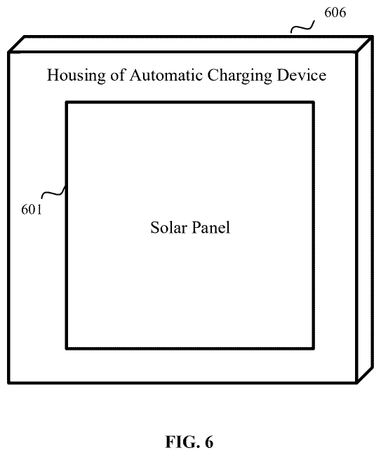

The smart door lock system including the automatic charging device for a smart door lock provided in various embodiments of the present disclosure can be configured in various configuration. FIG. 5 is a schematic diagram of an example automatic charging device for a smart door lock according to some embodiments of the present disclosure.

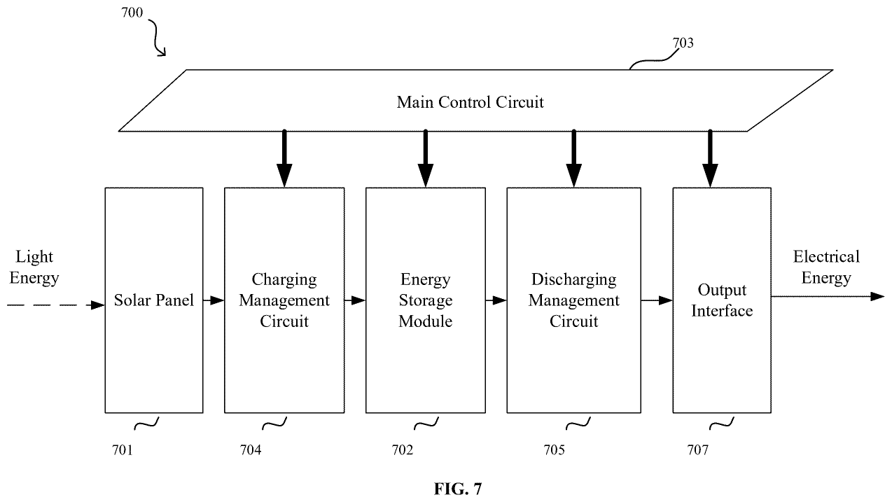

FIG. 6 is a block diagram of an example housing of an automatic charging device for a smart door lock according to some embodiments of the present disclosure. With further reference to FIG. 1, FIG. 5 and FIG. 6, in some embodiments, the entire charging receiving terminal 10 may be enclosed in the housing of the automatic charging device 120. For example, in FIG. 5, a housing 506 of an automatic charging device may enclose (include) optical receiver 501 and energy storage 502 of the charging receiving terminal 10 (FIG. 1). Additionally, the housing 506 may also include other portion of the charging receiving terminal 10, such as main control circuit 503. In FIG. 6, optical receiver 601 may be a solar panel to receive light energy from the external light sources. In this configuration, the solar panel 601 is on a face (side) of the automatic charging device housing 606.

The automatic charging device can be directly installed on the smart door lock or replace the existing module on the smart door lock without modifying the structure of the smart door lock, thereby enhancing the user experience. In some examples, smart door lock system 100 in FIG. 1 may be an integrated unit. For example, the automatic charging device 120 and the smart door lock 11 can be integrated, where the door lock body of the smart door lock is electrically connected to the automatic charging device. In some examples, the automatic charging device and the smart door lock may be arranged in a same housing, and installable in a door system. In other examples, the automatic charging device and the smart door lock can be separate units, where the automatic charging device acts as an external power source to provide power to the smart door lock. Similar arrangement may also be possible for other electronic devices.

FIG. 1 shows a configuration in which the external light sources (and/or charging transmitting terminal, e.g., 12 in FIG. 3) may be external to the automatic charging device 120 (in FIG. 1). In this configuration, the light source 121 of charging transmitting terminal 12 and/or the lens 122 (in FIG. 3) may be installed and aligned with the optical receiver of the smart door lock system (e.g., 101 in FIG. 1) such that light energy of the light source can be properly received by the optical receiver.

In other variations, one or more portions of the charging receiving terminal may be arranged in the automatic charging device, while other portions remain in the charging receiving terminal. For example, as shown in FIG. 4, lens 416 in the charging transmitting terminal may be arranged in the charging receiving terminal 410, instead of, or in addition to being disposed in the charging transmitting terminal (e.g., 12 in FIG. 3). In other variations, a smart door lock system as shown in FIG. 1 may also integrate the charging transmitting terminal (e.g., 12 in FIG. 3) therein.

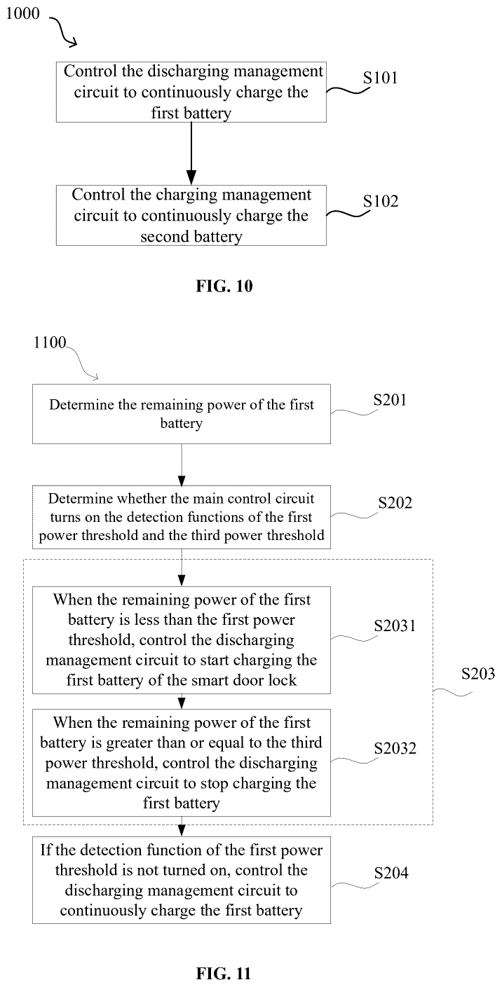

Having described various embodiments of a smart door lock system, multiple processes may be implemented to automatically charge a smart door lock of the system. In the present embodiment, a method for automatically charging a smart door lock is provided. FIG. 10 is a flow diagram of an example automatic charging method that may be implemented in a smart door lock system according to some embodiments of the present disclosure. In FIG. 10, method 1000 may be implemented in the smart door lock system 100 (in FIG. 1) or components thereof shown in FIGS. 2-9, for example, in MCU 803 (FIG. 8). As shown in FIG. 10, method 1000 includes controlling the discharging management circuit to continuously charge the first battery, at act S101. For example, when the main control circuit 803 (FIG. 8) controls the controllable switch Q2 (FIG. 9) to activate the voltage stabilizer 905, electrical energy in the Battery V is released to charge Battery A of the smart lock. In this manner, Battery A is in a continuous charging state.

Method 1000 may further include controlling the charging management circuit to continuously charge the second battery, at act S102. For example, when the main control circuit 803 (FIG. 8) controls the controllable switch Q1 (FIG. 9) to activate the voltage stabilizer 904, electrical energy in supercapacitor is released to continuously charge Battery V. In this manner, Battery V is in a continuous charging state and can continuously charge Battery A, to help maintain Battery A at the powered state.

In some embodiments, the charging management circuit and the discharging management circuit can be controlled independently depending on the status of the batteries such that the supercapacitor can release electrical energy from the optical receiver to the battery in the energy storage and/or the battery in the smart door lock. For example, when it is determined that both the battery in the energy storage and the battery in the smart door lock have low remaining power (e.g., below a power threshold such as 20%), both the charging management circuit and the discharging management circuits may be activated. In such manner, the energy storage battery does not have enough power to charge the smart door lock battery, the electrical energy from the supercapacitor are transferred to both the energy storage battery and the smart door lock battery. In non-limiting examples, when it is determined that the battery in the smart door lock have low remaining power (e.g., below a power threshold such as 20%), yet the battery in the energy storage does not have enough remaining power (e.g., below a power threshold such as 50%), both the charging management circuit and the discharging management circuits may be activated.

In non-limiting examples, when it is determined that the remaining power in the battery in the smart door lock is below a power threshold (e.g., below 20%) and the remaining power in the battery in the energy storage is above a power threshold (e.g., above 50%), the charging management circuit may be deactivated, while the discharging management circuits may be activated to release the electrical energy from the energy storage to the battery in the smart door lock. In some scenarios, charging management circuit and the discharging management circuits may be independently activated/deactivated depending on the battery status. These are described further with reference to FIGS. 11 and 12.

FIG. 11 is a flow diagram of another example automatic charging method that may be implemented in a smart door lock system according to some embodiments of the present disclosure. In FIG. 11, method 1100 may be implemented in the smart door lock system 100 (in FIG. 1) or components thereof shown in FIGS. 2-9, for example, in the MCU 803 (in FIG. 8). The first battery as referenced in method 1100 may be a battery in a smart door lock (e.g., Battery A in FIG. 9, or a battery in power unit 109 in FIG. 2). The discharging management circuit as referenced in method 1100 may be a suitable discharging management circuit as disclosed in FIGS. 2 and 7-9. The smart door lock as referenced in method 1100 may be a smart door lock as disclosed in FIGS. 1-2 (e.g., smart door lock 11).

As shown in FIG. 11, method 1100 may include determining the remaining power of the first battery, at act S201. The purpose of determining the remaining power of the first battery is to determine whether it is necessary to charge the first battery so that the first battery can be protected from overcharging when the battery is full. Method 1100 may further include determining whether the main control circuit (e.g., 803 in FIG. 8) turns on the detection functions for the first power threshold and the third power threshold, where the detection functions for the first power threshold and the third power threshold are configured to detect the power value of the first battery.

In some embodiments, the MCU (e.g., 803 in FIG. 8) may set the detection function for the first power threshold and the third power threshold for the first battery on or off, depending on a policy for determining when the detection function is on and when is off. For example, frequently detecting the power value of the battery helps to prevent the battery from being overcharged or undercharged and maintain the health of the battery. On the other hand, detecting the power value of the battery too frequently may result in a higher power consumption of the smart door lock system, thus decrease the efficiency of the system. In some examples, the policy for detecting power value of the battery may be pre-configured by the smart door lock system. In some examples, the policy for detecting power value of the battery may be configured by the user. For example, the user may use a keypad of the smart door lock system or an app to set a low-power (or energy saving) mode, for which the MCU selects a suitable policy that corresponds to the low-power mode. Additionally, and/or alternatively, the MCU may automatically configure a policy for turning on/off detecting function for the battery.

In some embodiments, determining remaining power of a battery may be implemented using a suitable circuit and/or software. For example, a voltage mapping method may be used. This method is based on correspondence between the battery's voltage and its remaining power. In some embodiments, the smart door lock system (e.g., 100 in FIG. 1) may include a detector circuit that includes a voltage sampling unit and a processing unit. The voltage sampling unit is configured to measure the voltage across the battery terminals. The processing unit pre-stores data of the battery's “voltage-power” correspondence curve. The processing unit queries this “voltage-power” correspondence curve based on the real-time voltage value collected by the voltage sampling unit to map the current remaining battery power. To obtain an accurate open-circuit voltage, this method can be executed when the system is in an idle state or under light load conditions.

Alternatively, and/or additionally, a coulomb counting method or a current integration method may be used. This method calculates the net change in charge by monitoring the current flowing into or out of the battery in real-time and integrating it over time. In some examples, the smart door lock system (e.g., 100 in FIG. 1) may include a current sampling unit, a clock unit, and a processing unit. The current sampling unit is configured to monitor the current flowing through the battery in real-time. The processing unit is configured to: integrate the collected current value over time to calculate the cumulative charge consumed or replenished; and compare this charge amount with the rated capacity of the battery to calculate the relative change in power. In non-limiting examples, Remaining Power=Initial Power+∫(Current) dt.

Alternatively, and/or additionally, an impedance measurement method or internal resistance analysis method may be used. This method is based on the characteristic that the internal resistance or electrochemical impedance of a battery changes with its state of charge and state of health. In some embodiments, the smart door lock system (e.g., 100 in FIG. 1) may include an excitation unit and a signal processing unit. The excitation unit can apply an AC excitation signal at a given frequency or an instantaneous load to the battery. The signal processing unit calculates the current internal resistance or impedance spectrum of the battery by detecting the response change in the battery terminal voltage. The processing unit compares the calculated impedance value with a pre-stored “impedance-power” model to estimate the remaining battery power. This method is also effective for judging the health state of the battery.

In some embodiments, the first power threshold and the third power threshold associated with the first battery may be pre-configured or may be automatically configured by the system. For example, the first power threshold may be set to 10%, 15%, 20%, or 25% of the power of the first battery. The third power threshold may be set to 80%, 85%, 90%, 95%, or 98% of the power of the first battery.

With further reference to FIG. 11, method 1100 may further include acts S203 in response to a determination that the detection function of the first power threshold and the third power threshold is turned on. Acts S203 may control the discharging management circuit to start or suspend charging the first battery based on the comparison results between the remaining power of the first battery and the first power threshold, as well as between the remaining power and the third power threshold, respectively.

In some embodiments, acts S203 include, at act S2031, when the remaining power of the first battery is less than the first power threshold, controlling the discharging management circuit to start charging the first battery of the smart door lock (e.g., Battery V in FIG. 9). In non-limiting examples, when the remaining power of the first battery is less than the first power threshold of 20%, the discharging management circuit is controlled to start charging the first battery, and charging continues until the power of the first battery exceeds the third power threshold of 95%, at which point the discharging management circuit is controlled to suspend charging the first battery of the smart door lock.

In some embodiments, acts S203 may further include, at act S2032: when the remaining power of the first battery is greater than or equal to the third power threshold, controlling the discharging management circuit to suspend charging the first battery of the smart door lock. In non-limiting examples, when the remaining power of the first battery is 96%, which is greater than or equal to 95%, the discharging management circuit is controlled to suspend charging the first battery. Controlling the discharging management circuit to charge or suspend charging the first battery may be implemented by respectively activating or deactivating the discharging management circuit (e.g., activating or deactivating the voltage stabilizer in the discharging management circuit), details of which are described with reference to FIGS. 8 and 9 and are not repeated herein.

Returning to FIG. 11, method 1100 may further include, at act S204, in response to determining that the detection function of the first power threshold is not turned on, controlling the discharging management circuit to continuously charge the first battery, for example, by activating the voltage stabilizer in the discharging management circuit.

FIG. 12 is a flowchart of yet another automatic charging method for a smart door lock system according to some embodiments of the present disclosure. In FIG. 12, method 1200 may be implemented in the smart door lock system 100 (in FIG. 1) or components thereof shown in FIGS. 2-9, for example, in the MCU 803 (in FIG. 8). The second battery as referenced in method 1200 may be a battery in energy storage, for example, Battery V in FIG. 9, or battery 108 in FIG. 2, or a battery in energy storage (e.g., energy storage 102 in FIG. 1, energy storage 702 in FIG. 7, energy storage 802 in FIG. 8). The charging management circuit as referenced in method 1200 may be a suitable charging management circuit as disclosed in FIGS. 2 and 7-9.

As shown in FIG. 12, method 1200 may include determining the remaining power of the second battery, at act S301. The purpose of determining the remaining power of the second battery is to determine whether it is necessary to charge the second battery.

Similar methods for determining the remaining power of the first battery as described with respect to method 1100 can also be used for determining the remaining power of the second battery. Method 1200 may further include: at act S302, determining whether the main control circuit turns on the detection functions for the second power threshold and the fourth power threshold, where the detection functions for the second power threshold and the fourth power threshold are configured to detect the power value of the second battery, and the second power threshold and the fourth power threshold are preset.

In some embodiments, the MCU (e.g., 803 in FIG. 8) may set the detection function for the second power threshold and the fourth power threshold for the second battery on or off in a similar manner as the detection function for the first power threshold and the third power threshold for the first battery is configured, such as according to a policy or a user configuration.

In some embodiments, the second power threshold and the fourth power threshold may be pre-configured or may be automatically configured by the system. For example, the second power threshold may be set to 10%, 15%, 20%, or 25% of the power of the second battery. The fourth power threshold may be set to 80%, 85%, 90%, 95%, or 98% of the power of the second battery.

With further reference to FIG. 12, method 1200 may further include acts S303 in response to a determination that the detection function of the second power threshold and the fourth power threshold is turned on. Acts S303 may control the charging management circuit to start or suspend charging the second battery based on the comparison results between the remaining power of the second battery and the second power threshold, as well as between the remaining power and the fourth power threshold, respectively.

In some embodiments, acts 303 may include, at act S3031, when the remaining power of the second battery is less than the second power threshold, controlling the charging management circuit to start charging the second battery until the remaining power of the second battery is greater than or equal to the fourth power threshold. In non-limiting examples, when the remaining power of the second battery is less than the second power threshold of 20%, the charging management circuit is controlled to start charging the second battery, and charging continues until the power of the second battery exceeds the fourth power threshold of 95%, at which point the charging management circuit 104 is controlled to suspend charging the second battery.

Acts 303 may further include, at act 3032, when the remaining power of the second battery is greater than or equal to the fourth power threshold, control the charging management circuit to suspend charging the second battery. In non-limiting examples, when the remaining power of the second battery is 96%, which is greater than or equal to the fourth power threshold of 95%, the charging management circuit is controlled to suspend charging the second battery. Controlling the charging management circuit to charge or suspend charging the second battery may be implemented by respectively activating or deactivating the charging management circuit (e.g., by activating or deactivating the voltage stabilizer in the charging management circuit), details of which are described with reference to FIGS. 8 and 9, and not repeated herein.

Returning to FIG. 12, method 1200 may further include, at act S304, in response to determining that the detection function for the second power threshold and the fourth power threshold is not turned on, controlling the charging management circuit to continuously charge the second battery, for example, by activating the voltage stabilizer in the charging management circuit.

The automatic charging methods for smart door locks provided in the embodiments of the present disclosure enable the main control circuit to set the first battery and the second battery to be in a continuous powered state, or set the first power threshold and the third power threshold to activate or deactivate the discharging management circuit, triggering the start or stop of charging for the first battery. Similarly, the method set the second power threshold and the fourth power threshold to activate or deactivate the charging management circuit, triggering the start or stop of charging for the second battery. These embodiments provide advantages in that the energy storage and the smart door lock can be in powered states continuously, maintaining the smart door lock system in continuous operation without the need to remove the battery from the system for charging.

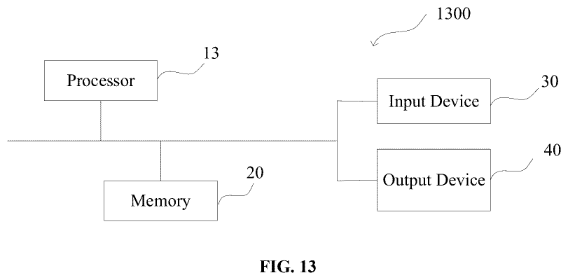

FIG. 13 is schematic diagram of an example computer device 1300 that may be implemented in an electronic device, such as a smart door lock system, according to some embodiments of the present disclosure. In some examples, computer device 1300 may be implemented in the automatic charging device 120 (in FIG. 1), and/or main control circuit (e.g., 103 in FIGS. 2, 503 in FIGS. 5, 703 in FIGS. 7, 803 in FIG. 8). As shown in FIG. 13, the computer device 1300 includes: one or more processors 13, a memory 20, and interfaces for connecting various components, including a high-speed interface and a low-speed interface. The various components are communicatively connected to each other using different buses, and can be provided on a common motherboard or provided in other ways as needed. The processor can process instructions executed in the computer device, including instructions stored in or on the memory to display graphical information of a GUI on an external input/output device (such as a display device coupled to the interface). In some optional implementations, a plurality of processors and/or a plurality of buses can be used together with a plurality of memories and a plurality of storages if required. Similarly, a plurality of computer devices can be connected, with each device providing part of the necessary operations (for example, as a server array, a group of blade servers, or a multi-processor system). One processor 13 is taken as an example in FIG. 13.

The processor 10 may be a central processing unit, a network processor, or a combination thereof. The processor 10 may further include a hardware chip. The aforementioned hardware chip may be an application-specific integrated circuit, a programmable logic device, or a combination thereof. The aforementioned programmable logic device may be a complex programmable logic device, a field-programmable gate array, a generic array logic, or any combination thereof.

The memory 20 stores instructions executable by at least one processor 10, enabling the at least one processor 10 to execute the methods described in the aforementioned embodiments.

The memory 20 may include a program storage area and a data storage area, where the program storage area can store an operating system and application programs required for at least one function. The data storage area can store data established according to the use of the computer device for displaying applet landing pages, etc. In addition, the memory 20 may include a high-speed random access memory, and may also include non-volatile memory, such as at least one magnetic disk storage device, flash memory device, or other non-volatile solid-state storage devices. In some optional implementations, the memory 20 may optionally include memories remotely disposed relative to the processor 10, and these remote memories may be connected to the computer device through a network. Examples of the aforementioned networks include, but are not limited to, the Internet, an intranet, a local area network, a mobile communication network, and combinations thereof.

The memory 20 may include volatile memory, such as a random access memory. The memory may also include non-volatile memory, such as flash memory, a hard disk, or a solid-state drive. The memory 20 may further include a combination of the aforementioned types of memories.

The computer device further includes an input device 30 and an output device 40. The processor 10, the memory 20, the input device 30, and the output device 40 may be connected via a bus or other means, and FIG. 13 illustrates the connection via a bus as an example.

The input device 30 can receive input digital or character information and generate key signal inputs related to user settings and function control of the computer device, such as a touch screen, keypad, mouse, trackpad, touchpad, pointing stick, one or more mouse buttons, trackball, joystick, etc. The output device 40 may include a display device, auxiliary lighting devices (for example, LEDs), and haptic feedback devices (for example, vibration motors), etc. The aforementioned display devices include, but are not limited to, liquid crystal displays, light-emitting diodes, displays, and plasma displays. In some optional implementations, the display device may be a touch screen.

The embodiment of the present disclosure further provides a computer-readable storage medium. The method according to the embodiment of the present disclosure can be implemented in hardware, firmware, or recorded in a storage medium, or implemented as computer code that is originally stored in a remote storage medium or a non-transitory machine-readable storage medium via network download and will be stored in a local storage medium. Therefore, the method described herein can be stored as such software processing on a storage medium using a general-purpose computer, a dedicated processor, or programmable or dedicated hardware. The storage medium may be a magnetic disk, an optical disk, a read-only memory, a random access memory, a flash memory, a hard disk, or a solid-state drive, etc. Optionally, the storage medium may also include a combination of the aforementioned types of memories. It can be understood that a computer, processor, microprocessor controller, or programmable hardware includes a storage component that can store or receive software or computer code. When the software or computer code is accessed and executed by the computer, processor, or hardware, the methods shown in the aforementioned embodiments are implemented.

Although the embodiments of the present disclosure have been described with reference to the accompanying drawings, those skilled in the art can make various modifications and variations without departing from the spirit and scope of the present disclosure, and such modifications and variations all fall within the scope defined by the appended claims.

The indefinite articles “a” and “an,” as used herein in the specification and in the claims, unless clearly indicated to the contrary, should be understood to mean “at least one. ” As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements.

This allows elements to optionally be present other than the elements specifically identified within the list of elements to which the phrase “at least one” refers, whether related or unrelated to those elements specifically identified.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of. ” “Consisting essentially of,” when used in the claims, shall have its ordinary meaning as used in the field of patent law.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting.

1. An automatic charging device for a smart door lock, the automatic charging device comprising a charging receiving terminal comprising:
an optical receiver configured to receive light energy from external light sources and convert the light energy from the external light sources to electrical energy;
an energy storage coupled to the optical receiver and configured to store the electrical energy from the optical receiver and further provide the electrical energy to charge the smart door lock;
a charging management circuit coupled to the optical receiver and the energy storage and configured to release the electrical energy from the optical receiver to the energy storage; and
a control unit configured to monitor a status of the energy storage and the smart door lock, and based on the monitoring, control the charging management circuit to transfer the electrical energy from the optical receiver to the energy storage.

2. The automatic charging device of claim 1, wherein the smart door lock comprises a first battery and the energy storage comprises a second battery, and wherein the charging management circuit is configured to:
operate in a charge state to provide charging to the second battery; or
operate in a suspend state to suspend charging to the second battery.

3. The automatic charging device of claim 2, wherein:
the charging management circuit comprises:
a supercapacitor coupled to the optical receiver and configured to store electrical energy from the optical receiver, and
a voltage stabilizer coupled to the supercapacitor and the second battery;
when the charging management circuit is in the charge state, the voltage stabilizer is activated to release electrical energy stored in the supercapacitor to the second battery; and
when the charging management circuit is in the suspend state, the voltage stabilizer is deactivated to suspend release of electrical energy stored in the supercapacitor to the second battery.

4. The automatic charging device of claim 3, wherein:
the voltage stabilizer comprises a switch coupled to the control unit to receive a control signal therefrom;
when the voltage stabilizer is activated, the switch is configured to alternately turn on and off in response to the control signal from the control unit such that electrical energy stored in the supercapacitor is released to the second battery; and
when the voltage stabilizer is deactivated, an open circuit is formed between the switch and the control unit such that release of the electrical energy from the supercapacitor to the second battery is suspended.

5. The automatic charging device of claim 4, wherein the control signal is a pulse width modulation signal.

6. The automatic charging device of claim 1, further comprising:
a discharging management circuit coupled to the energy storage and the smart door lock and configured to release the electrical energy from the energy storage to charge the smart door lock;
wherein the discharging management circuit is configured to:
operate in a charge state to provide charging to the first battery; or
operate in a suspend state to suspend charging to the first battery.

7. The automatic charging device of claim 6, wherein:
the discharging management circuit comprises a voltage stabilizer;
when the discharging management circuit is in the charge state, the voltage stabilizer is activated to release electrical energy stored in the second battery to the first battery; and
when the discharging management circuit is in the suspend state, the voltage stabilizer is deactivated to suspend release of electrical energy stored in the second battery to the first battery.

8. The automatic charging device of claim 7, wherein:
the voltage stabilizer comprises a switch coupled to the control unit to receive a control signal therefrom;
when the voltage stabilizer is activated, the switch is configured to alternately turn on and off in response to the control signal from the control unit such that electrical energy stored in the second battery is released to the first battery; and
when the voltage stabilizer is deactivated, an open circuit is formed between the switch and the control unit such that release of the electrical energy from the second battery to the first battery is suspended.

9. A method for automatically charging a smart door lock, the method comprising:
determining remaining power of a first battery in the smart door lock;
determining whether detection functions for a first power threshold and a third power threshold are turned on;
in response to determining that the detection functions for the first power threshold and the third power threshold are turned on, controlling a discharging management circuit in a charging device to start or suspend charging the first battery according to comparisons between the remaining power of the first battery and the first power threshold, and between the remaining power of the first battery and the third power threshold, respectively; and
in response to determining that the detection functions for the first power threshold and the third power threshold are not turned on, controlling the discharging management circuit to continuously charge the first battery.

10. The method of claim 9, wherein controlling the discharging management circuit in the charging device to start or suspend charging the first battery comprises:
determining whether the remaining power of the first battery is less than the first power threshold; and
in response to determining that the remaining power of the first battery is less than the first power threshold, charging the first battery until the remaining power of the first battery exceeds the third power threshold;
otherwise, suspending charging the first battery.

11. The method of claim 10, further comprises:
determining remaining power of a second battery in the charging device for the smart door lock;
determining whether detection functions for a second power threshold and a fourth power threshold are turned on;
in response to determining that the detection functions for the second power threshold and the fourth power threshold are turned on, controlling a charging management circuit in the charging device to start or suspend charging the second battery according to comparisons between the remaining power of the second battery and the second power threshold, and between the remaining power of the second battery and the fourth power threshold, respectively; and
in response to determining that the detection functions for the second power threshold and the fourth power threshold are not turned on, controlling the charging management circuit to continuously charge the second battery.

12. The method of claim 11, wherein controlling the charging management circuit in the charging device to start or suspend charging the second battery comprises:
determining whether the remaining power of the second battery is less than the second power threshold; and
in response to determining that the remaining power of the second battery is less than the second power threshold, charging the second battery until the remaining power of the second battery exceeds the fourth power threshold;
otherwise, suspending charging the second battery.

13. The method of claim 12, wherein:
charging the second battery comprising releasing electrical energy from a supercapacitor to the second battery; and
charging the first battery comprises releasing electrical energy from the second battery to the first battery.

14. The method of claim 13, further comprising:
at an optical receiver coupled to the supercapacitor, receiving light energy from external light sources and converting the light energy from the external light sources to electrical energy; and
storing the electrical energy in the supercapacitor.

15. The method of claim 13, wherein controlling the charging management circuit in the charging device further comprises:
in response to determining that the remaining power of the first battery is less than the first power threshold:
determining whether the remaining power of the second battery exceeds a fifth power threshold for charging the first battery; and
in response to determining that the remaining power of the second battery exceeds the fifth power threshold, charging the first battery by releasing electrical energy from the second battery to the first battery;
otherwise, charging the first battery by releasing electrical energy from the supercapacitor to the second battery and to the first battery, wherein the supercapacitor is coupled to an optical receiver to store electrical energy from the optical receiver, the optical receiver is configured to receive light energy from external light sources and convert the light energy to the electrical energy.

16. The method of claim 15, wherein:
when the charging management circuit is in the charge state, activating a voltage stabilizer coupled to the second battery to cause release of electrical energy stored in the supercapacitor to the second battery; and
when the charging management circuit is in the suspend state, deactivating the voltage stabilizer to suspend release of electrical energy stored in the supercapacitor to the second battery.

17. The method of claim 16, wherein:
activating the voltage stabilizer comprises, at a control unit, providing a control signal to a switch of the voltage stabilizer to alternately turn on and off the switch; and
deactivating the voltage stabilizer comprises forming an open circuit between the switch of the voltage stabilizer and the control unit.

18. The method of claim 17, wherein the control signal is a pulse width modulation signal.

19. An automatic charging device for a battery-operated electronic device, wherein the battery-operated electronic device comprises a first battery, the automatic charging device is coupled to the electronic device to provide charge to the electronic device, the automatic charging device comprising a charging receiving terminal comprising:
an optical receiver configured to receive light energy from external light sources and convert the light energy from the external light sources to electrical energy;
an energy storage comprising a second battery, the energy storage being coupled to the optical receiver;
a charging management circuit coupled to the optical receiver and the energy storage and configured to release the electrical energy from the optical receiver to charge the second battery of the energy storage;
a discharging management circuit coupled to the energy storage and the electronic device and configured to release the electrical energy from the energy storage to charge the first battery; and
a control unit configured to monitor a status of the energy storage and the electronic device, and control the charging management circuit and the discharging management circuit to transfer the electrical energy from the optical receiver to the second battery to the first battery.

20. The automatic charging device of claim 19, wherein:
the charging management circuit comprises:
a supercapacitor coupled to the optical receiver and configured to store electrical energy from the optical receiver; and
a voltage stabilizer coupled to the supercapacitor and the second battery; and
wherein the charging management circuit is configured to:
operate in a charge state, in which the voltage stabilizer is activated to release electrical energy stored in the supercapacitor to the second battery; or
operate in a suspend state, in which the voltage stabilizer is deactivated to suspend release of electrical energy stored in the supercapacitor to the second battery.
